(19) United States
(12) Patent Application Publication
(10) Pub. No.: US 2016/0085292 A1
(43) Pub. Date: Mar. 24, 2016

(54) ELECTRONIC DEVICE

(71) Applicant: KABUSHIKI KAISHA TOSHIBA, Tokyo (JP)

(72) Inventors: Koichi Fujisaki, Kawasaki (JP); Tetsuro Kimura, Tokyo (JP); Tatsunori Kanai, Yokohama (JP); Junichi Segawa, Kawasaki (JP); Masaya Tarui, Yokohama (JP); Satoshi Shirai, Kawasaki (JP); Yusuke Shirota, Yokohama (JP); Akihiro Shibata, Tokyo (JP); Shiyo Yoshimura, Kawasaki (JP)

(21) Appl. No.: 14/847,144

(22) Filed: Sep. 8, 2015

(30) Foreign Application Priority Data
Sep. 18, 2014 (JP) 2014-190370

(51) Int. Cl. G06F 1/32

(52) U.S. Cl. CPC G06F 1/3287

(57) ABSTRACT

According to an embodiment, an electronic device includes functional modules and converters. A processor includes a memory storing state information on the state of the processor. Each converter converts the power-supply voltage to a rated voltage for functional modules, and supplies the rated voltage to at least one functional module. When the processor switches to the standby state, a controller stops the supply of the rated voltages to the functional modules except a state holding unit, a receiving unit, and the controller; and stops the operations of the converters not connected to the state holding unit, the receiving unit, and the controller. The state holding unit holds the state information before the processor switches to the standby state. The receiving unit receives a return signal representing the trigger for returning from the standby state. The state holding unit, the receiving unit, and the controller are connected to the same converter.

### CROSS-REFERENCE TO RELATED APPLICATIONS

This application is based upon and claims the benefit of priority from Japanese Patent Application No. 2014-190370, filed on Sep. 18, 2014; the entire contents of which are incorporated herein by reference.

### FIELD

An embodiment described herein relates generally to an electronic device.

### BACKGROUND

A technology called system-on-chip (SoC) is known in which various functional modules are built into a single device, and the functions required in an integrated system (an electronic device) can be provided using a single device. Since an SoC has various functions built thereinto, multiple voltages are required to drive the SoC. The voltages required in the SoC are generated using a plurality of DC-DC converters from the power supply of the integrated system in which the SoC is installed.

However, in an electronic device in which multiple voltages are required, because of the need to use a plurality of DC-DC converters, the power consumption during the standby state of the processor becomes large.

### BRIEF DESCRIPTION OF THE DRAWINGS

FIG. 1 is a diagram illustrating an exemplary configuration (in the operating state) of an electronic device according to an embodiment;

FIG. 2 is a diagram illustrating exemplary signal lines in a system-on-chip (SoC) according to the embodiment;

FIG. 3 is a diagram illustrating an exemplary configuration (in the standby state) of the electronic device according to the embodiment; and

FIG. 4 is a flowchart for explaining a power supply method implemented in the electronic device according to the embodiment.

### DETAILED DESCRIPTION

According to an embodiment, an electronic device includes a plurality of functional modules and a plurality of converters. At least one of the plurality of functional modules is a processor capable of switching to a standby state having reduced power consumption. At least one of the plurality of functional modules is a state holding unit. At least one of the plurality of functional modules is a receiving unit. At least one of the plurality of functional modules is a controller. The processor includes a memory that stores state information related to state of the processor therein. Each of the plurality of converters converts power-supply voltage to a rated voltage for the functional modules, and supplies the rated voltage to at least one of the functional modules. When the processor switches to the standby state, the controller stops supply of the rated voltages to the functional modules except the state holding unit, the receiving unit, and the controller and stops operations of the converters not connected to the state holding unit, the receiving unit, and the controller. The state holding unit holds the state information before the processor switches to the standby state. The receiving unit receives a return signal representing a trigger for returning from the standby state. In response to the return signal received by the receiving unit, the processor writes back the state information, which is held by the state holding unit, into the memory. The state holding unit, the receiving unit, and the controller are connected to same converter from among the converters.

An embodiment of an electronic device is described below in detail with reference to the accompanying drawings.

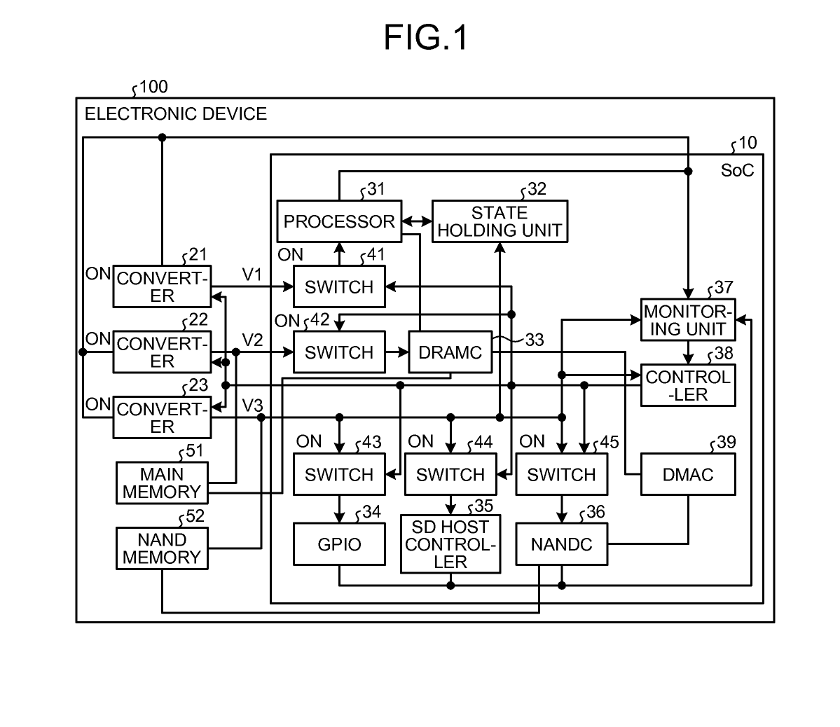

FIG. 1 is a diagram illustrating an exemplary configuration (in the operating state) of an electronic device 100 according to the embodiment. The electronic device 100 according to the embodiment includes an SoC 10 and converters 21 to 23.

The SoC 10 according to the embodiment includes a processor 31, a state holding unit 32, a dynamic random access memory controller (DRAMC) 33, a general purpose input/output (GPIO) 34, an SD host controller 35, a NAND memory controller (NANDC) 36, a monitoring unit 37, a controller 38, a direct memory access controller (DMAC) 39, switches 41 to 45, a main memory 51, and a NAND memory 52. Herein, the SoC 10 according to the embodiment is a semiconductor chip that includes, as a plurality of functional modules, the processor 31, the state holding unit 32, the DRAMC 33, the GPIO 34, the SD host controller 35, the NANDC 36, the monitoring unit 37, the controller 38, and the DMAC 39.

Given below is the explanation of exemplary signal lines used for sending and receiving data within the SoC 10.

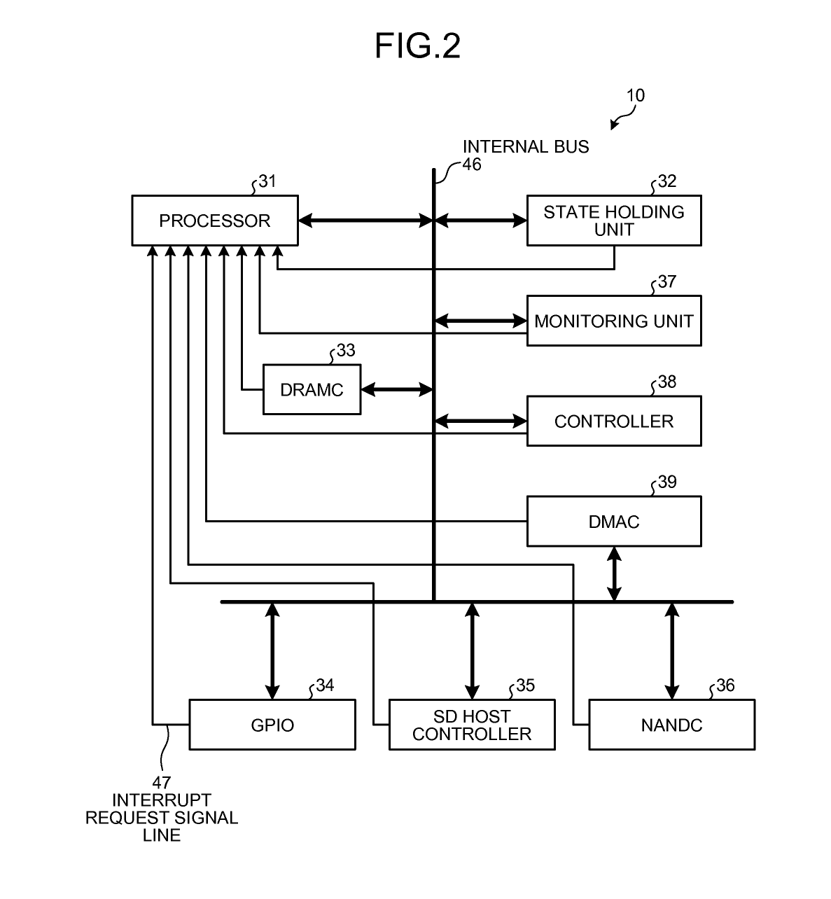

FIG. 2 is a diagram illustrating exemplary signal lines in the SoC 10 according to the embodiment. The processor 31, the state holding unit 32, the DRAMC 33, the GPIO 34, the SD host controller 35, the NANDC 36, the monitoring unit 37, the controller 38, and the DMAC 39 are connected to each other by an internal bus 46. Thus, the processor 31, the state holding unit 32, the DRAMC 33, the GPIO 34, the SD host controller 35, the NANDC 36, the monitoring unit 37, the controller 38, and the DMAC 39 perform data communication, such as reading and writing of data, via the internal bus 46.

Moreover, the state holding unit 32, the DRAMC 33, the GPIO 34, the SD host controller 35, the NANDC 36, the monitoring unit 37, the controller 38, and the DMAC 39 are connected to the processor 31 by interrupt request signal lines 47 that are used in sending interrupt request signals representing interrupt processing requests. For example, when data or signals are received by the GPIO 34 from the outside of the SoC 10, the GPIO 34 sends an interrupt request signal to the processor 31 and notifies the processor 31 about the reception of the target data for processing. Upon receiving the interrupt request signal, the processor 31 performs operations according to the interrupt request signal.

Returning to the explanation with reference to FIG. 1, the converters 21 to 23 according to the embodiment represent DC-DC converters. The converter 21 supplies a voltage of V1 volts to the processor 31. The converter 22 supplies a voltage of V2 volts to the DRAMC 33. The converter 23 supplies a voltage of V3 volts to the state holding unit 32, the GPIO 34, the SD host controller 35, the NANDC 36, the monitoring unit 37, and the controller 38. Thus, in the SoC 10 according to the embodiment, three types of voltages V1 to V3 are used in accordance with the rated voltages for operating the processor 31, the state holding unit 32, the DRAMC 33, the GPIO 34, the SD host controller 35, the NANDC 36, the monitoring unit 37, and the controller 38. In the explanation about the electronic device 100 according to the embodiment, it is assumed that the relation of V1<V2<V3 is satisfied. For example, the voltage V1 is equal to 1.25 volts, the voltage V2 is equal to 1.8 volts, and the voltage V3 is equal to 3.3 volts. However, that is not the only possible case.

The processor 31 controls the operations of the electronic device 100 by executing computer programs. The processor 31 has two states, namely, the operating state and the standby state. That is, the processor 31 can switch from the operating state to the standby state, and vice versa. In the operating state, the processor 31 executes the computer programs to be executed. However, in the standby state, the power supply to the processor 31 is disconnected.

Alternatively, in the standby state, instead of disconnecting the power supply to the processor 31, the power consumption of the processor 31 can be reduced to a lower level than the power consumption in the operating state. Meanwhile, the processor 31 includes a memory (not illustrated) that stores state information related to the state of the processor 31 therein. For example, the memory is a register such as a program counter register, a return register, or a general-purpose register. However, that is not the only possible case. Before the processor 31 switches from the operating state to the standby state, the state information related to the state of the processor 31 is written in the state holding unit 32. The conditions for the processor 31 to switch from the operating state to the standby state include, for example, a condition in which there is no processing target for the processor 31 (such as a case of waiting for an input from a device outside of the SoC 10). In response to a return signal received by the GPIO 34, the processor 31 writes back the state information, which is related to the state thereof and which is held by the state holding unit 32 (described later), in the memory.

The processor 31 writes, in an internal control register of the monitoring unit 37, the information about the functional modules that should to be supplied with electricity when the processor 31 switches to the standby state during activation or during execution of computer programs.

In the SoC 10, the processor 31 has a high operating frequency because it is expected to perform high-speed processing. In order to achieve a high operating frequency, the voltages of the signals in the processor 31 need to have low amplitude. That is because, in order to make the processor 31 operate at high speeds, the transition between signal lines also needs to happen at high speeds.

More particularly, in order to switch between the signal lines at high speeds, the voltages of the signals need to step up and step down at high speeds. When the operating frequency is high, the voltage needs to step up to a threshold voltage in an extremely short period of time. The circuit enabling the voltage to step up to the threshold value has a correlation with the threshold voltage of signals. When the threshold voltage is high, the circuit for driving the signals becomes large and has increased power consumption. Hence, regarding the voltage supplied to the processor 31 in the SoC 10, higher the expected processing capacity of the SoC 10, the better it is to have low voltage supplied to the processor 31. The voltage supplied to the processor 31 can be decided freely by the vendor of the SoC 10. Hence, in the electronic device 100 according to the embodiment, the converter 21 is installed as a dedicated converter for the processor 31.

The state holding unit 32 stores the state information related to the state of the processor 31 therein. Herein, the processor 31 includes a plurality of registers, and the state of the processor 31 is determined in accordance with the data held by the registers. Examples of the registers of the processor 31 include a program counter register that controls the execution of computer programs, a link register, a stack register, and general-purpose registers that temporarily hold the calculation results. These registers are used by the computer programs running in the processor 31.

In this way, the state information related to the state of the processor 31 before switching to the standby state is held in registers such as program counter registers, return registers, or general-purpose registers. For that reason, at a time of disconnecting the power supply to the processor 31 in the standby state, all information held in the registers of the processor 31 is read and is then written in the state holding unit 32.

At a time of returning from the standby state, the information of registers held in the holding unit 32 is written back in the registers of the processor 31, so that the processor 31 can return to the state in which the information was copied in the state holding unit 32.

In this way, as a result of writing the state of the registers of the processor 31 in the state holding unit 32, even when the power supply to the processor 31 is disconnected for the purpose of electrical power saving, the processor 31 can return to the original state when the power supply resumes.

The state information related to the state of the processor 31 is either written in the state holding unit 32 directly by the processor 31 or written in the state holding unit 32 by a device used for reading and writing the state information related to the state of the processor 31.

To the state holding unit 32, the converter 23 supplies the voltage V3. For that reason, even if the operations of the converter 21, which supplies the voltage V1 to the processor 31, are stopped; the state holding unit 32 can continue to hold the information written therein.

The DRAMC 33 is a memory controller that performs control of writing and reading with respect to a dynamic random access memory (DRAM). The voltage of the DRAMC 33 is often different from the global standard of other devices. Hence, in the electronic device 100 according to the embodiment, the converter 22 is installed as a dedicated converter for the DRAMC 33.

The GPIO 34 functions as an interface for establishing connection with an external device, and enables signal reception and signal transmission between the SoC 10 and an external device. That is, for example, the GPIO 34 functions as a receiving unit that receives a return signal representing a trigger for the processor 31 to return from the standby state, and notifies the monitoring unit 37 about the reception of the return signal.

The SD host controller 35 is a memory controller that performs control for writing and reading with respect to an SD memory.

The NANDC 36 is a memory controller that performs control for writing and reading with respect to a NAND memory.

The monitoring unit 37 monitors, according to the information stored in the internal control register thereof, the operating state of the converters 21 to 23, the processor 31, the GPIO 34, the SD host controller 35, and the NANDC 36.

For example, the monitoring unit 37 receives the signals sent from the processor 31, and monitors whether or not the processor 31 has switched to the standby state. When the processor 31 switches to the standby state, the monitoring unit 37 notifies the controller 38 about the fact that the processor 31 has switched to the standby state. Moreover, for example, the monitoring unit 37 receives the signals sent from the GPIO 34, and monitors whether or not the abovementioned return signal is received. If the return signal is received, then the monitoring unit 37 notifies the controller 38 about the reception of the return signal.

As the return signal, as long as the return signal is received by the SoC 10, it is not limited to a signal input to the GPIO 34. That is, if a universal asynchronous receiver-transmitter (UART) is installed as a functional module, then a signal used in UART communication is used as the return signal. Alternatively, if a serial peripheral interface (SPI) is installed as a functional module, then a signal used in SPI communication is used as the return signal.

Furthermore, the monitoring unit 37 monitors, for example, the voltages of the converters 21 to 23, the processor 31, the GPIO 34, the SD host controller 35, and the NANDC 36; and accordingly monitors whether or not the converters 21 to 23, the processor 31, the GPIO 34, the SD host controller 35, and the NANDC 36 are operating in a normal manner.

The monitoring unit 37 can be implemented using dedicated hardware or using a processor, which is different from the processor 31, and software.

When the controller 38 receives, from the monitoring unit 37, a notification that the state information related to the processor 31 is held by the state holding unit 32 and that the processor 31 has switched to the standby state; the controller 38 turns the switch 41 OFF and stops the supply of the voltage V1 to the processor 31. Moreover, at that time, the controller 38 stops the operations of the converter 21. When the controller 38 receives, from the monitoring unit 37, a notification that the processor 31 has switched to the standby state; the controller 38 turns the switch 42 OFF and stops the supply of the voltage V2 to the DRAMC 33. Moreover, when the controller 38 receives, from the monitoring unit 37, a notification that the processor 31 has switched to the standby state; the controller 38 turns the switches 44 and 45 OFF and stops the supply of the voltage V3 to the SD host controller 35 and the NANDC 36. As a result, the power supply to the SD host controller 35 and the NANDC 36, which are not used while waiting for an input from outside, is disconnected. Thus, when the processor 31 switches to the standby state, the controller 38 stops the supply of the rated voltages to the functional modules except the state holding unit 32, the GPIO 34, the monitoring unit 37, and the controller 38 itself.

The controller 38 receives in advance, from the processor 31, a specification indicating which functional module is to be used in waiting for an input from outside. According to the specification, the controller 38 keeps the power supply to the functional module to be used in waiting for an input from outside, and disconnects the power supply to the remaining functional modules. That enables achieving reduction in the power consumption in the standby state.

Besides, when it is necessary to reduce the power consumption, the converter 22 is stopped from operating. At that time, if the main memory 51 is a nonvolatile memory such as a magnetoresistive random access memory (MRAM), the controller 38 sends a signal for stopping the operations of the converter 22 without copying the data stored in the main memory.

However, if the main memory 51 is a volatile memory such as a DRAM, then the information stored in the main memory 51 needs to be copied in a nonvolatile storage device before stopping the operations of the converter 22.

More particularly, the information stored in the main memory 51 is written in the NAND memory 52, which is illustrated in FIG. 1, via the DMAC 39. After the data transfer is completed, the DMAC 39 sends a transfer completion signal to the controller 38 as a notification that the power supply to the main memory 51 can be disconnected.

Upon receiving the transfer completion signal from the DMAC 39, the controller 38 stops the operations of the converter 22.

Moreover, the controller 38 receives, from the monitoring unit 37, the information related to the operating state or the information about the voltages of the functional modules and the converters 21 to 23, which are monitored by the monitoring unit 37. When it is determined that the monitoring targets can switch to the operating state, the controller 38 sends an operation enable signal or an interrupt request signal to the processor 31. With that, the controller 38 switches the processor 31 (the electronic device 100) from the standby state to the operating state.

In an identical manner to the monitoring unit 37, the functions of the controller 38 can be implemented using dedicated hardware or using a processor, which is different from the processor 31, and software. Alternatively, the controller 38 can also be implemented as a software function in the processor in which the functions of the monitoring unit 37 are implemented.

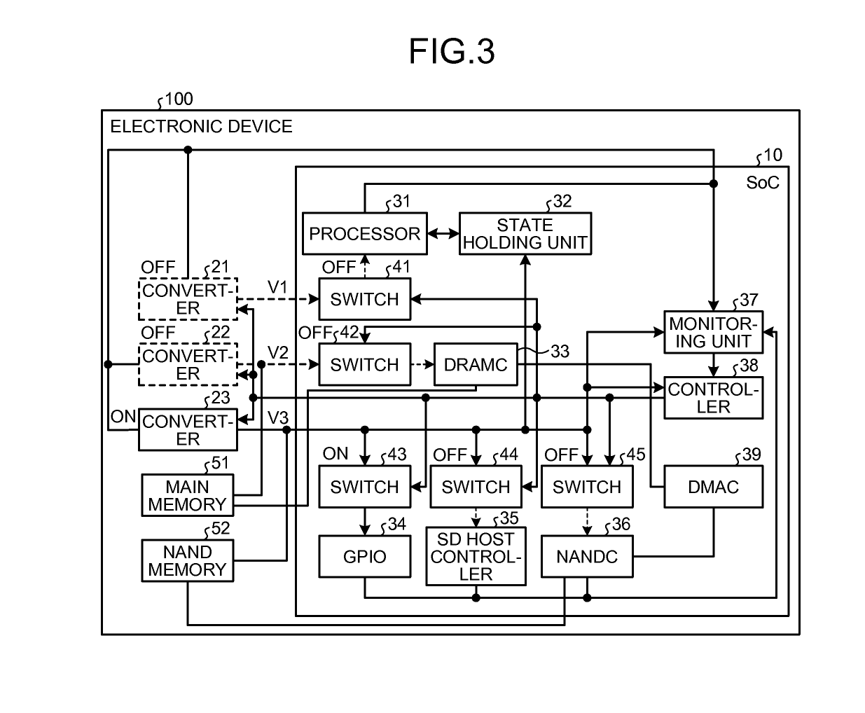

FIG. 3 is a diagram illustrating an exemplary configuration (in the standby state) of the electronic device 100 according to the embodiment. When the processor 31 switches to the standby state, the controller 38 stops the voltage supply to the functional modules (the processor 31, the DRAMC 33, the SD host controller 35, and the NANDC 36) except the state holding unit 32, the GPIO 34, the monitoring unit 37, and the controller 38 itself. Moreover, the controller 38 stops the operations of the converters 21 and 22.

As a result, in the electronic device 100 according to the embodiment, it becomes possible to hold down the power consumption when the electronic device 100 (the processor 31) switches to the standby state.

Given below is the explanation of the power consumption reduction effect of the electronic device 100 according to the embodiment. In the converters 21 to 23 (in the DC-DC converters), not all of the energy (Eᵢₙ) input during voltage conversion can be output (Eₒᵤₜ). That is, there occurs a loss (ELₒₛₜ) accompanying the voltage conversion. Thus, the input (Eᵢₙ) and the output (Eₒᵤₜ) have the relationship as given below in Equation (1).

Eᵢₙ=Eₒᵤₜ+ELₒₛₜ (1)

One of the factors of the loss (ELₒₛₜ) is the electrical power (Eₗₒₛₜ) consumed during the operations of the converter (22 and 23). Herein, the power consumption is in the range of a few milliwatts to 10 milliwatts. Thus, if there is an increase in the number of converters 21 (22 and 23) required in voltage conversion, the power consumption for voltage conversion also increases in proportion. If n represents the number of converters, then the loss becomes equal to (n*Eₗₒₛₜ). In the electronic device 100 according to the embodiment, the loss (ELₒₛₜ) is considered to be equal to the loss (n*Eₗₒₛₜ).

Regarding the power consumption attributed to the loss (n*Eₗₒₛₜ) in the converters 21 to 23, depending on the state of the electronic device 100 (the integrated system), there are times when the power consumption can be ignored and there are times when some countermeasure is required.

When the SoC 10 of the electronic device 100 is operational, the power consumption (E_{soc}_{_{—}}_{active}) of this system is equal to or greater than a few watts. At that time, in comparison with the power consumption (E_{system}) of the entire electronic device 100, the loss (3*Eₗₒₛₜ) in the converters 21 to 23 is extremely small and poses little problem. If E_{etc} represents the power consumption of the functional modules other than the SoC 10 and the converters 21 to 23, then Equation (2) given below holds true.

E_{system}=E_{soc}_{_{—}}_{active}+3*Eₗₒₛₜ+E_{etc} (2)

Herein, since E_{soc}_{_{—}}_{active}>>3*Eₗₒₛₜ holds true, Equation (3) given below holds true.

E_{system}≈E_{soc}_{_{—}}_{active}+E_{etc} (3)

However, in the standby state (E_{soc}_{_{—}}_{idle}) of the SoC 10 (the processor 31), the power consumption of the SoC 10 also decreases to a few milliwatts. Hence, there are times when the power consumption of the converters 21 to 23 is close to half of the power consumption of the entire electronic device 100 (E_{soc}_{_{—}}_{idle}≈3*Eₗₒₛₜ). In such a state of low power consumption, the power consumption of the converters 21 to 23 becomes problematic.

In the standby state (E_{soc}_{_{—}}_{idle}) of the electronic device 100 according to the embodiment, since the operations of the converters 21 to 23 are stopped, the power consumption 3*Eₗₒₛₜ can be reduced to the power consumption Eₗₒₛₜ. As a result, without affecting the high-speed processing capacity of the SoC 10, it becomes possible to hold down the power consumption when the electronic device 100 (the processor 31) switches to the standby state.

Meanwhile, greater the difference between the power-supply voltage and a rated voltage, greater becomes the power consumption Eₗₒₛₜ of the corresponding converter. For that reason, the controller 38 receives supply of the electrical power from the converter which, of the rated voltages used in the electronic device 100, supplies the rated voltage having the smallest difference with the power-supply voltage. That makes it possible to further hold down the power consumption upon switching to the standby state. In the electronic device 100 according to the embodiment, the converter 23 supplies the rated voltage having the smallest difference with the power-supply voltage. Thus, in the standby state, only the converter 23 is kept operational.

Returning to the explanation with reference to FIG. 3, before the controller 38 switches to the standby state, if an input from outside is received by the functional module such as the GPIO 34 that is specified in advance to be used in the return to the operating state, a notification is sent to the monitoring unit 37 from the functional module.

In response, the monitoring unit 37 notifies the controller 38 about the reception of a return signal. Upon receiving the signal, the controller 38 resumes the operations of the converter 21. Then, the controller 38 turns the switch 41 ON so that the supply of the voltage V1 to the processor 31 resumes.

Moreover, if the operations of the converter 22 have been stopped, the controller 38 resumes the operations of the converter 22 and, once the converter 22 becomes operational, turns the switch 42 ON so that the supply of the voltage V2 to the DRAMC 33 resumes.

Moreover, when the main memory 51 is a volatile memory, the controller 38 turns the switch 45 ON and supplies the voltage V3 to the NANDC 36 so that the information that was copied in the NAND memory 52 can be rewritten in the main memory 51.

After the DRAMC 33 and the NANDC 36 that are required in data transfer become operable, the controller 38 instructs the DMAC 39 to transfer the information stored in the NAND memory 52 to the main memory 51, and waits for the completion of data transfer performed by the DMAC 39.

While the data transfer is underway, the monitoring unit 37 instructs the controller 38 to turn the switches 44 ON so that the supply of the voltage V3 to the SD host controller 35 resumes.

Until the processor 31 becomes operable, in order to not notify the processor 31 about an interrupt from outside, the monitoring unit 37 blocks inputs to the interrupt controller in the processor 31 or blocks notifications of interrupts from the interrupt controller to the processor 31.

When the monitoring unit 37 confirms that the data has been written back in the main memory 51 from the NAND memory 52 and confirms that the register data has been written back in the processor 31 from the state holding unit 32, the controller 38 ensures that the processor 31 switches from the standby state to the operating state due to an external interrupt. More particularly, the controller 38 sends an interrupt signal to the interrupt controller in the processor 31, and then the interrupt controller sends an interrupt signal notifying about an interrupt from outside to the processor 31.

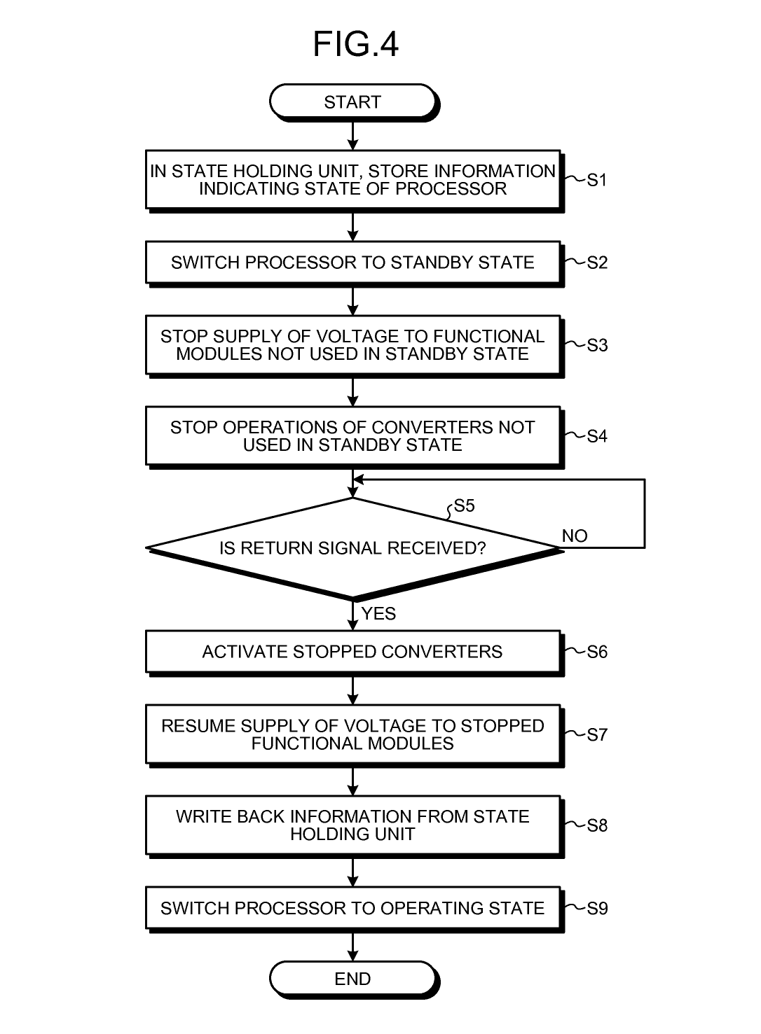

Given below is the explanation of the method of operation of the electronic device 100 according to the embodiment. FIG. 4 is a flowchart for explaining a power supply method implemented in the electronic device 100 according to the embodiment.

Before the processor 31 switches from the operating state to the standby state, the state information related to the state of the processor 31 is stored in the state holding unit (Step S1). Then, the processor 31 switches to the standby state (Step S2).

Subsequently, the controller 38 stops the voltage supply to the functional modules that are not used in the standby state (Step S3). More particularly, when a notification that the processor 31 has switched to the standby state is received from the monitoring unit 37, the controller 38 turns the switch 41 OFF and stops the supply of the voltage V1 to the processor 31. Moreover, the controller 38 turns the switch 42 OFF and stops the supply of the voltage V2 to the DRAMC 33. Furthermore, the controller 38 turns the switches 44 and 45 OFF and stops the supply of the voltage V3 to the SD host controller 35 and the NANDC 36.

Then, the controller 38 stops the operations of the converters 21 and 22 that are not used in the standby state (Step S4).

Subsequently, the monitoring unit 37 monitors whether or not a return signal is received from an external device of the SoC 10 (Step S5). Until a return signal is received (No at Step S5), the reception of the return signal is awaited.

When a return signal is received (Yes at Step S5), the monitoring unit 37 notifies the controller 38 about the reception of the return signal, and the controller 38 activates the converters 21 and 22 that were stopped at Step S4 (Step S6).

Then, the controller 38 resumes the voltage supply to the functional modules stopped at Step S3 (Step S7). More particularly, the controller 38 turns the switch 41 ON and resumes the supply of the voltage V1 to the processor 31. Moreover, the controller 38 turns the switch 42 ON and resumes the supply of the voltage V2 to the DRAMC 33. Furthermore, the controller 38 turns the switches 44 and 45 ON and resumes the supply of the voltage V3 to the SD host controller 35 and the NANDC 36.

Subsequently, the processor 31 writes back, in the internal registers thereof, the information stored in the state holding unit 32 at Step S1 (Step S8). When the monitoring unit 37 confirms that the data has been written back and confirms that the necessary functional modules are operable, the controller 38 notifies the processor 31 about an interrupt from outside and the processor 31 switches from the standby state to the operating state (Step S9).

As described above, in the electronic device 100 according to the embodiment, the bare minimum functional modules (the state holding unit 32, the GPIO 34, the monitoring unit 37, and the controller 38) required for the return to the operating state (reactivation) are connected to a single power supply (the converter 23). For that reason, in the standby state of the electronic device (the processor 31), the controller 38 can stop the remaining power supplies (the converters 21 and 22). Moreover, in the electronic device 100 according to the embodiment, in the standby state of the electronic device 100 (the processor 31), the controller 38 turns the switches 44 and 45 OFF and stops the voltage supply to the SD host controller 35 and the NANDC 36. Therefore, according to the embodiment, it becomes possible to reduce the power consumption of the electronic device 100 in the standby state.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An electronic device comprising:
a plurality of functional modules; and
a plurality of converters, wherein
at least one of the plurality of functional modules is a processor capable of switching to a standby state having reduced power consumption,
at least one of the plurality of functional modules is a state holding unit,
at least one of the plurality of functional modules is a receiving unit,
at least one of the plurality of functional modules is a controller,
the processor includes a memory that stores state information related to state of the processor therein,
each of the plurality of converters converts power-supply voltage to a rated voltage for the functional modules, and supplies the rated voltage to at least one of the functional modules,
when the processor switches to the standby state, the controller stops supply of the rated voltages to the functional modules except the state holding unit, the receiving unit, and the controller and stops operations of the converters not connected to the state holding unit, the receiving unit, and the controller,
the state holding unit holds the state information before the processor switches to the standby state,
the receiving unit receives a return signal representing a trigger for returning from the standby state,
in response to the return signal received by the receiving unit, the processor writes back the state information, which is held by the state holding unit, into the memory, and
the state holding unit, the receiving unit, and the controller are connected to same converter from among the converters.

2. The device according to claim 1, wherein the controller receives supply of electrical power from the converter that, of the rated voltages used in the electronic device, supplies the rated voltage having smallest difference with the power-supply voltage.

3. The device according to claim 1, further comprising a monitoring unit to:
monitor whether or not the processor has switched to the standby state and monitor whether or not the receiving unit has received the return signal, and
notify the controller about the processor switching to the standby state or about the receiving unit receiving the return signal, wherein
the monitoring unit is connected to the converter that supplies the rated voltage to the state holding unit, the receiving unit, and the controller.

4. The device according to claim 1, wherein the controller controls whether or not to supply electrical power having the rated voltage to the plurality of functional modules by using switches provided between the plurality of converters and the plurality of functional modules.
